(19) United States
(12) Patent Application Publication
(10) Pub. No.: US 2022/0137543 A1
(43) Pub. Date: May 5, 2022

(54) SELECTION OF TRAY BASED ON REMAINING LIFETIME OF TRAYS

(71) Applicant: Hewlett-Packard Development Company, L.P., Spring, TX (US)

(72) Inventor: Gyeong Hun Jo, Pangyo (KR)

(73) Assignee: Hewlett-Packard Development Company, L.P., Spring, TX (US)

(21) Appl. No.: 17/299,762

(22) PCT Filed: Jan. 16, 2020
(86) PCT No.: PCT/US2020/013832

§ 371 Date: Jun. 3, 2021

(30) Foreign Application Priority Data
Jul. 19, 2019 (KR) 10-2019-0087271

(51) Int. Cl. G03G 15/00

(52) U.S. Cl. CPC G03G 15/55; G03G 15/6502

(57) ABSTRACT

An example image forming apparatus including a plurality of trays includes a plurality of sensors, a processor, and an image forming unit. The plurality of sensors measure at least one of noise or vibration occurring in the plurality of trays. The processor selects a tray to be used for an image forming operation, based on a remaining lifetime of each of the plurality of trays estimated based on data about at least one of the noise or the vibration measured by the plurality of sensors. The image forming unit performs an image forming operation on a print medium supplied from the selected tray.

### BACKGROUND

An image forming apparatus such as a printer, a copier, a scanner, a fax machine, or a multi-function printer may include a plurality of trays for use of a large amount of paper or for use of different types, sizes, etc. of paper. In order to perform an image forming operation, the image forming apparatus may use a print medium supplied from a particular tray selected by a user or from a tray designated by default.

### BRIEF DESCRIPTION OF THE DRAWINGS

FIG. 1 is a diagram illustrating an image forming apparatus including a plurality of trays according to an example;

FIG. 2 is a diagram illustrating a schematic structure and operation of an image forming apparatus according to an example;

FIG. 3 is a block diagram illustrating a configuration of an image forming apparatus according to an example;

FIG. 4 is a diagram illustrating image forming apparatuses communicating with a diagnostic server according to an example;

FIG. 5 is a flowchart illustrating a method of controlling an image forming apparatus including a plurality of trays according to an example;

FIG. 6 is a flowchart illustrating a process of selecting a tray to be used for an image forming operation among a plurality of trays according to an example; and

FIG. 7 is a diagram illustrating a result of selecting a tray by an image forming apparatus in various cases in which a plurality of trays are in different states according to an example.

### DETAILED DESCRIPTION OF EXAMPLES

Hereinafter, various examples will be described with reference to the drawings. In the specification and drawings, like reference numerals may denote like elements having substantially the same functions and configurations, and redundant descriptions thereof may be omitted for conciseness.

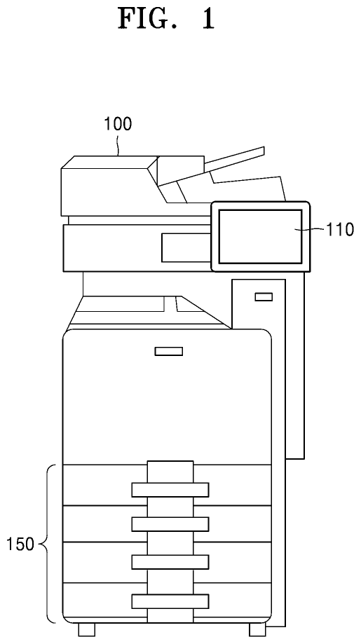

FIG. 1 is a diagram illustrating an image forming apparatus including a plurality of trays according to an example.

Referring to FIG. 1, an image forming apparatus 100 may refer to any device capable of performing an image forming operation, such as a printer, a copier, a scanner, a fax machine, or a multi-function printer. An image forming operation (or job) may refer to any of various operations related to an image, such as printing, copying, scanning, or faxing, and may include a series of processes necessary for performing an image forming operation.

The image forming apparatus 100 may receive a request for an image forming operation from a user through a user interface device 110 and perform the requested image forming operation. In order to perform the requested image forming operation, the image forming apparatus 100 should be supplied with a print medium such as paper. For this, the image forming apparatus 100 may include a plurality of trays 150. One or more of the plurality of trays may be loaded with a print medium so that the image forming apparatus 100 may use the print medium loaded into the one or more trays 150 to perform an image forming operation.

In an example, the trays 150 of the image forming apparatus 100 may be arranged in a multistage form. In an example, the image forming apparatus 100 may include a plurality of trays 150 by additionally mounting a separate tray.

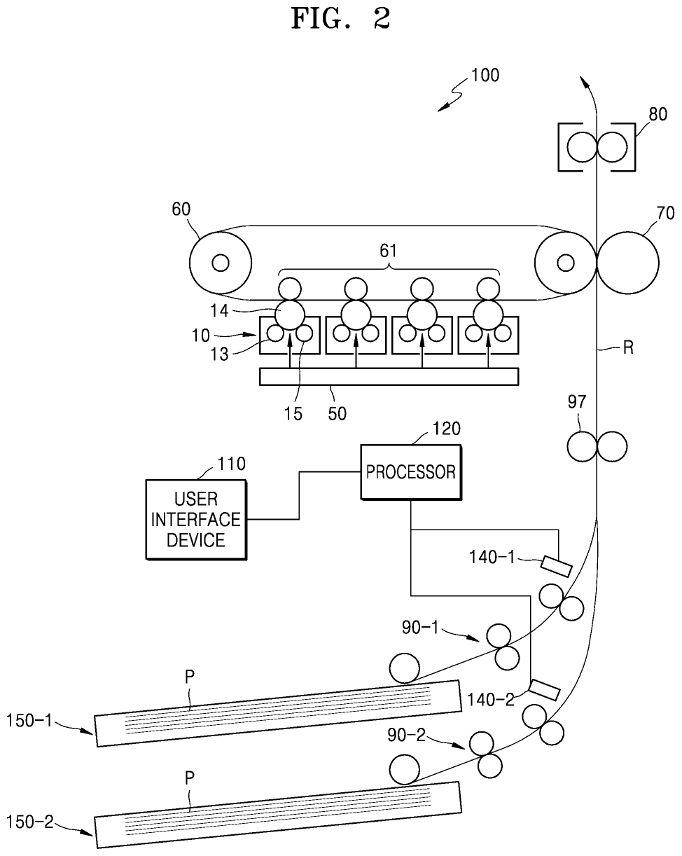

FIG. 2 is a diagram illustrating a schematic structure and operation of an image forming apparatus according to an example.

Referring to FIG. 2, the image forming apparatus 100 may print a color image by an electrophotographic development method. A developing device 10 may include a photoconductor 14, on the surface of which an electrostatic latent image may be formed, and a developing roller 13 for supplying a developer to the photoconductor 14 to develop the electrostatic latent image into a visible toner image. The photoconductor 14 may include a photosensitive drum and may include an organic photo conductor (OPC). A charging roller 15 may be provided as a charger for charging the photoconductor 14 to have a uniform surface potential. The developer contained in a developer cartridge (not illustrated) may be supplied to the developing device 10. The developer contained in the developer cartridge (not illustrated) may include a toner and may include a carrier.

An exposure device 50 may form an electrostatic latent image on the photoconductor 14 by irradiating the photoconductor 14 with light that is modulated corresponding to image information. The exposure device 50 may include a laser scanning unit (LSU), or the like.

A transfer unit may transfer the toner image formed on the photoconductor 14 to a print medium P and may be an intermediate transfer-type transfer unit. As an example, the transfer unit may include an intermediate transfer medium 60, an intermediate transfer roller 61, and a transfer roller 70. The intermediate transfer medium 60 may include an intermediate transfer belt to temporarily receive a toner image developed on and transferred from the photoconductor 14 of each of a plurality of developing devices 10. An intermediate transfer bias for intermediately transferring the toner image developed on the photoconductor 14 to the intermediate transfer medium 60 may be applied to a plurality of intermediate transfer rollers 61. The transfer roller 70 may be located to face the intermediate transfer medium 60. A transfer bias for transferring the toner image transferred to the intermediate transfer medium 60 to the print medium P may be applied to the transfer roller 70.

A fixing unit 80 may apply heat and/or pressure to the toner image transferred to the print medium P to fix the toner image to the print medium P.

The exposure device 50 may scan light that is modulated corresponding to image information of each color to the photoconductor 14 of each of the plurality of developing devices 10 to form an electrostatic latent image on the photoconductor 14. The electrostatic latent image on the photoconductor 14 of a plurality of developing devices 10 may be developed into a visible toner image by cyan (C), magenta (M), yellow (Y), and black (K) developers supplied from a plurality of developer cartridges (not illustrated) to a plurality of developing devices 10. The developed toner images may be sequentially intermediately-transferred to the intermediate transfer medium 60.

A print medium P loaded into a first tray 150-1 may be fed along a feed path R by a first print medium feed device 90-1. For example, the print medium P loaded into the first tray 150-1 may be fed by the first print medium feed device 90-1 between the transfer roller 70 and the intermediate transfer medium 60. A first sensor 140-1, for measuring at least one of noise or vibration occurring in the first tray 150-1, may be located at a predetermined position relative to the first print medium feed device 90-1. A print medium P loaded into a second tray 150-2 may be fed along the feed path R by a second print medium feed device 90-2. For example, the print medium P loaded into the second tray 150-2 may be fed by the second print medium feed device 90-2 between the transfer roller 70 and the intermediate transfer medium 60. A second sensor 140-2, for measuring at least one of noise or vibration occurring in the second tray 150-2, may be located at a predetermined position relative to the second print medium feed device 90-2. Although terms including ordinals such as “first” or “second” may be used herein to describe various elements or components, these elements or components should not be limited by these terms. These terms are only used to distinguish one element or component from another element or component. Although FIG. 2 illustrates an example including two trays 150-1 and 150-2, that is, the first tray 150-1 and the second tray 150-2, the present disclosure is not limited thereto.

The toner image intermediately-transferred onto the intermediate transfer medium 60 by a transfer bias voltage applied to the transfer roller 70 may be transferred to the print medium P. When the print medium P passes through the fixing unit 80, the toner image may be fixed to the print medium P by heat and pressure. The print medium P on which the fixing is completed may be discharged by a discharge roller (not illustrated).

Each of the first print medium feed device 90-1 and the second print medium feed device 90-2 may include various rollers such as a pickup roller, a forward roller, and a feed roller and may include at least one driving unit (not illustrated) for driving such rollers. The respective pickup rollers may pick up the print medium P loaded into the first and second trays 150-1 and 150-2, the respective forward rollers may forward the picked-up print medium P toward the feed path R, and the respective feed rollers may feed the print medium P along the feed path R to a print medium aligning unit 97 including a registration roller. In an example, the respective feed rollers may change the speed at which the print medium P is fed from the first and second trays 150-1 and 150-2.

The first sensor 140-1 may measure at least one of noise or vibration occurring in the first tray 150-1. For example, the first sensor 140-1 may be located near the feed roller of the first print medium feed device 90-1 to measure at least one of noise or vibration occurring at a predetermined portion on the feed path R of the print medium when the print medium is picked up and fed from the first tray 150-1. However, the position of the first sensor 140-1 is not limited thereto. The second sensor 140-2 may measure at least one of noise or vibration occurring in the second tray 150-2. For example, the second sensor 140-2 may be located near the feed roller of the second print medium feed device 90-2 to measure at least one of noise or vibration occurring at a predetermined portion on the feed path R of the print medium when the print medium is picked up and fed from the second tray 150-2. However, the position of the second sensor 140-2 is not limited thereto.

The print medium aligning unit 97 including the registration roller may align a front end of the print medium P and supply the aligned print medium to an image forming unit. The print medium aligning unit 97 may correct a front end skew of the print medium P and match the front end of an image of the print operation to the corrected front end of the print medium P. When the front end of the print medium P and the front end of the image of the print operation are matched by the print medium aligning unit 97, the image formed on the intermediate transfer medium 60 may be transferred to the print medium P and the transferred image may be fixed by the fixing unit 80.

The user interface device 110 may receive a user input for controlling an operation of the image forming apparatus 100 or provide an output for indicating an operation state of the image forming apparatus 100. A processor 120 may control an operation of the image forming apparatus 100. The user interface device 110 may receive a request for an image forming operation and may receive a user input necessary for performing an image forming operation. The user interface device 110 may provide a screen for an image forming operation or a tray setting to the user and, in response thereto, may receive a user input necessary for performing an image forming operation or a tray setting from the user.

In an example, the image forming apparatus 100 may select a tray to be used for an image forming operation from among a plurality of trays 150 when having to automatically select a tray because the user does not designate a particular tray. In another example, the image forming apparatus 100 may select a tray to be used for an image forming operation from among the plurality of trays 150 when having to automatically select a tray because there is no tray corresponding to an attribute of an image forming operation. In another example, the image forming apparatus 100 may select a tray to be used for an image forming operation from among the plurality of trays 150 when having to automatically select a tray because a particular tray designated by the user is unusable. Hereinafter, a description will be given of an example of controlling the image forming apparatus 100 in a case where the image forming apparatus 100 includes a plurality of trays 150 and automatically selects a tray.

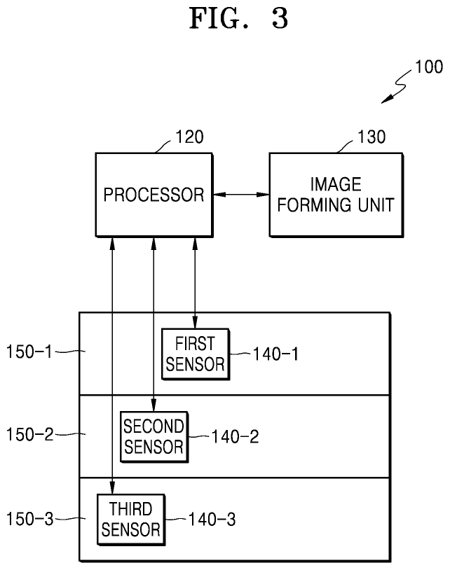

FIG. 3 is a block diagram illustrating a configuration of an image forming apparatus according to an example.

Referring to FIG. 3, the image forming apparatus 100 may include a processor 120, an image forming unit 130, and a plurality of sensors 140-1, 140-2, and 140-3 for measuring at least one of noise or vibration occurring in a plurality of trays 150-1, 150-2, and 150-3.

The plurality of sensors 140-1, 140-2, and 140-3 may respectively correspond to the plurality of trays 150-1, 150-2, and 150-3. Although FIG. 3 illustrates a total of three trays including a first tray 150-1, a second tray 150-2, and a third tray 150-3 and a total of three sensors including a first sensor 140-1, a second sensor 140-2, and a third sensor 140-3 respectively corresponding thereto, the correspondence therebetween and the number thereof are not limited thereto.

Each of the plurality of sensors 140-1, 140-2, and 140-3 may measure at least one of noise or vibration occurring in the plurality of trays 150-1, 150-2, and 150-3. For example, each of the plurality of sensors 140-1, 140-2, and 140-3 may measure at least one of noise or vibration occurring in each of the plurality of trays 150-1, 150-2, and 150-3 corresponding thereto. In an example, each of the plurality of sensors 140-1, 140-2, and 140-3 may be an acceleration sensor. The acceleration sensor may include a piezoelectric acceleration sensor as a sensor capable of measuring a dynamic force such as acceleration, vibration, or impact of an object. The acceleration sensor may sense a vibration, convert the vibration into a voltage, and output the same. As another example, each of the plurality of sensors 140-1, 140-2, and 140-3 may be a noise measuring sensor. The noise measuring sensor may be provided with a microphone to acquire ambient noise and output the measured noise level. As another example, each of the plurality of sensors 140-1, 140-2, and 140-3 may be a noise/vibration measuring sensor capable of measuring both noise and vibration.

Each of the plurality of sensors 140-1, 140-2, and 140-3 may be located at a predetermined position relative to a print medium feed device (not illustrated) that is provided at each of the plurality of trays 150-1, 150-2, and 150-3. Each of the print medium feed devices may be respectively provided to supply the print medium P loaded into each of the plurality of trays 150-1, 150-2, and 150-3 to the image forming unit 130. In an example, each of the plurality of sensors 140-1, 140-2, and 140-3 may be located at a position where noise or vibration occurs most in a print medium feed device (not illustrated) provided at each of the plurality of trays 150-1, 150-2, and 150-3.

The processor 120 may select a tray to be used for an image forming operation. For example, the processor 120 may select a tray to be used for an image forming operation based on a remaining lifetime of each of the plurality of trays 150-1, 150-2, and 150-3. The remaining lifetime of each of the plurality of trays 150-1, 150-2, and 150-3 may be estimated based on data about at least one of the noise or the vibration measured by the sensors 140-1, 140-2, and 140-3. The processor 120 may select a tray with the longest remaining lifetime by comparing the remaining lifetime of each of the plurality of trays 150-1, 150-2, and 150-3 whenever there is a request for an image forming operation. Because a tray with the longest remaining lifetime is preferentially selected from among the plurality of trays 150-1, 150-2, and 150-3 whenever selecting a tray to be used for an image forming operation, the plurality of trays 150-1, 150-2, and 150-3 may be uniformly used and the possibility of occurrence of a failure may be reduced.

The processor 120 may estimate the remaining lifetime of each of the plurality of trays 150-1, 150-2, and 150-3 by comparing the data about at least one of the noise or the vibration measured by the plurality of sensors 140-1, 140-2, and 140-3 with reference data mapped and stored for each tray. The reference data mapped and stored for each tray may include data regarding a remaining lifetime of each tray. Data about at least one of noise or vibration occurring in each of the plurality of trays 150-1, 150-2, and 150-3 may be acquired by performing data amplification or signal processing and extraction on the data about at least one of the noise or the vibration measured by the plurality of sensors 140-1, 140-2, and 140-3, considering the position or characteristic of each of the plurality of trays 150-1, 150-2, and 150-3.

With respect to a guaranteed lifetime of each of the plurality of trays 150-1, 150-2, and 150-3, the image forming apparatus 100 may store, in a memory (not illustrated), data about at least one of the noise or the vibration measured by the plurality of sensors 140-1, 140-2, and 140-3 at predetermined use time intervals and use the stored data as reference data. Each of the plurality of sensors 140-1, 140-2, and 140-3 may measure at least one of noise or vibration from a time when feeding of the print medium starts to a time when the print medium exits the tray.

The feed time of the print medium in each tray may vary due to a feeding speed of the print medium P. For example, the feeding speed of the print medium P may vary according to the size, the type, or the like of the print medium P. Accordingly, the noise or vibration occurring in each tray may also vary. Considering this variation, at least one of noise or vibration may be measured and used for each tray. Among the data about at least one of the noise or the vibration measured as such, data of a significant interval or an average value of the data may be used as reference data.

By comparing the data about at least one of the noise or the vibration measured by the plurality of sensors 140-1, 140-2, and 140-3 with the reference data mapped and stored for each tray, the processor 120 may determine the remaining lifetime of each of the plurality of trays 150-1, 150-2, and 150-3. For example, the processor 120 may determine the remaining lifetime of each of the plurality of trays 150-1, 150-2, and 150-3 based on a similarity between the data about at least one of the noise or the vibration measured by the plurality of sensors 140-1, 140-2, and 140-3 and reference data mapped and stored for each remaining lifetime of each tray. For example, a similarity between the measured data and the reference data about at least one of the noise or the vibration may be calculated by a Euclidean distance therebetween. The similarity therebetween may decrease as the Euclidean distance between the reference data and the measured data about at least one of the noise or the vibration increases, and the similarity therebetween may increase as the Euclidean distance therebetween decreases. The processor 120 may determine the remaining lifetime mapped to the reference data with the highest similarity between the reference data and the measured data about at least one of the noise or the vibration as the remaining lifetime of the tray.

The remaining lifetime of each of the plurality of trays 150-1, 150-2, and 150-3 may be further estimated based on at least one of the feed count (i.e., the number of feeding times) or the feed failure rate of each tray in addition to the data about at least one of the noise or the vibration measured by the plurality of sensors 140-1, 140-2, and 140-3. For example, the remaining lifetime of each of the plurality of trays 150-1, 150-2, and 150-3 may be estimated based on the data about at least one of the noise or the vibration measured by each of the plurality of sensors 140-1, 140-2, and 140-3 and the feed count of each tray. As another example, the remaining lifetime of each of the plurality of trays 150-1, 150-2, and 150-3 may be estimated based on the data about at least one of the noise or the vibration measured by each of the plurality of sensors 140-1, 140-2, and 140-3 and the feed failure rate of each tray. As another example, the remaining lifetime of each of the plurality of trays 150-1, 150-2, and 150-3 may be estimated based on the data about at least one of the noise or the vibration measured by each of the plurality of sensors 140-1, 140-2, and 140-3, the feed count of each tray, and the feed failure rate of each tray.

The remaining lifetime of each of the plurality of trays 150-1, 150-2, and 150-3 may be calculated by weighting each of a first remaining lifetime estimated based on the data about at least one of the noise or the vibration measured by the plurality of sensors 140-1, 140-2, and 140-3, a second remaining lifetime estimated based on the feed count of each tray, and a third remaining lifetime estimated based on the feed failure rate of each tray.

The second remaining lifetime determined based on the feed count of each tray may be calculated based on the ratio of the guaranteed feed count of each tray to the remainder of the guaranteed feed count of each tray minus the actual feed count of each tray.

The third remaining lifetime determined based on the feed failure rate of each tray may be calculated to be as much as the lifetime corresponding to the remaining ratio excluding a failure rate from 100% with respect to the guaranteed lifetime of each tray. In this case, when the successive feed failure count (i.e., the number of times of successive feed failures) is greater than or equal to a predetermined reference value, the third remaining lifetime may be calculated by weighting the failure rate.

The remaining lifetime of each of the plurality of trays 150-1, 150-2, and 150-3 may be calculated by weighting each of the first remaining lifetime and the second remaining life, may be calculated by weighting each of the first remaining lifetime and the third remaining lifetime, or may be calculated by weighting each of the first remaining lifetime, the second remaining lifetime, and the third remaining lifetime.

Various data used to estimate the remaining lifetime of each of the plurality of trays 150-1, 150-2, and 150-3 may be stored in a memory (not illustrated).

The image forming unit 130 may perform an image forming operation on the print medium P supplied from the tray selected as a tray to be used for an image forming operation.

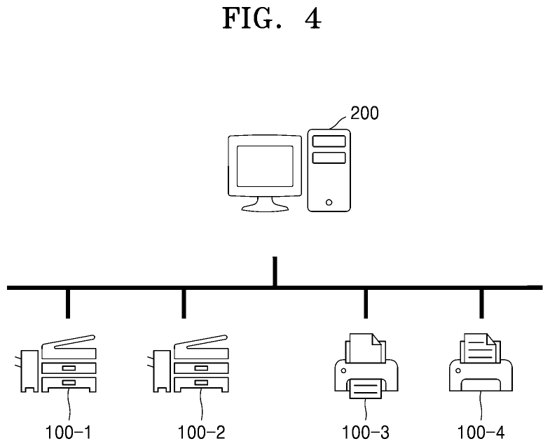

FIG. 4 is a diagram illustrating image forming apparatuses communicating with a diagnostic server according to an example.

Referring to FIG. 4, a diagnostic server 200 may communicate with a plurality of image forming apparatuses 100-1, 100-2, 100-3, and 100-4. Each of the plurality of image forming apparatuses 100-1, 100-2, 100-3, and 100-4 may include a communication interface device (i.e., a transceiver, not illustrated) for performing communication with the diagnostic server 200.

A processor (not illustrated) of any image forming apparatus 100 among the image forming apparatuses 100-1, 100-2, 100-3, and 100-4 may determine the remaining lifetime of each of a plurality of trays 150 based on information received from the diagnostic server 200 through a communication interface device (not illustrated) in response to transmission of data about at least one of the noise or the vibration measured by a plurality of sensors (not illustrated) corresponding to the plurality of trays 150 to the diagnostic server 200. The information received from the diagnostic server 200 may be the remaining lifetime of each of the plurality of trays 150 estimated by the diagnostic server 200. An example method of estimating the remaining lifetime of each of the plurality of trays 150 by the diagnostic server 200 is substantially the same as the example method described with reference to FIG. 3, and thus redundant descriptions thereof will be omitted for conciseness.

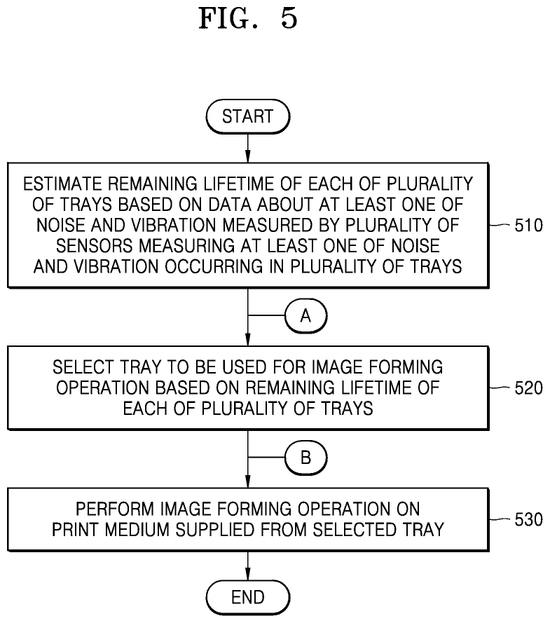

FIG. 5 is a flowchart illustrating a method of controlling an image forming apparatus including a plurality of trays according to an example.

Referring to FIG. 5, the image forming apparatus 100 may estimate the remaining lifetime of each of the plurality of trays 150 based on data about at least one of noise or vibration occurring in the plurality of trays 150 measured by a plurality of sensors in operation 510. The plurality of sensors may respectively correspond to the plurality of trays 150. Each of the plurality of sensors may be located at a predetermined position relative to a print medium feed device that is provided at each of the plurality of trays 150 to supply a print medium loaded into each of the plurality of trays 150 to an image forming unit.

The image forming apparatus 100 may estimate the remaining lifetime of each of the plurality of trays 150 by comparing the data about at least one of the noise or the vibration measured by the plurality of sensors with reference data mapped and stored for each remaining lifetime of each tray. Alternatively, the image forming apparatus 100 may determine the remaining lifetime of each of the plurality of trays 150 based on information received from a diagnostic server 200 in response to transmission of the data about at least one of the noise or the vibration measured by the plurality of sensors to the diagnostic server 200. The information received from the diagnostic server 200 may be the remaining lifetime of each of the plurality of trays 150 estimated by the diagnostic server 200.

The remaining lifetime of each of the plurality of trays 150 may be further estimated based on at least one of the feed count and the feed failure rate of each tray in addition to the data about at least one of the noise or the vibration measured by the plurality of sensors.

The image forming apparatus 100 may calculate the remaining lifetime of each of the plurality of trays 150 by weighting each of a first remaining lifetime estimated based on the data about at least one of the noise or the vibration measured by the plurality of sensors, a second remaining lifetime estimated based on the feed count of each tray, and a third remaining lifetime estimated based on the feed failure rate of each tray.

In operation 520, the image forming apparatus 100 may select a tray to be used for an image forming operation based on the estimated remaining lifetime of each of the plurality of trays 150.

The image forming apparatus 100 may select a tray with the longest remaining lifetime by comparing the remaining lifetime of each of the plurality of trays 150 whenever there is a request for an image forming operation.

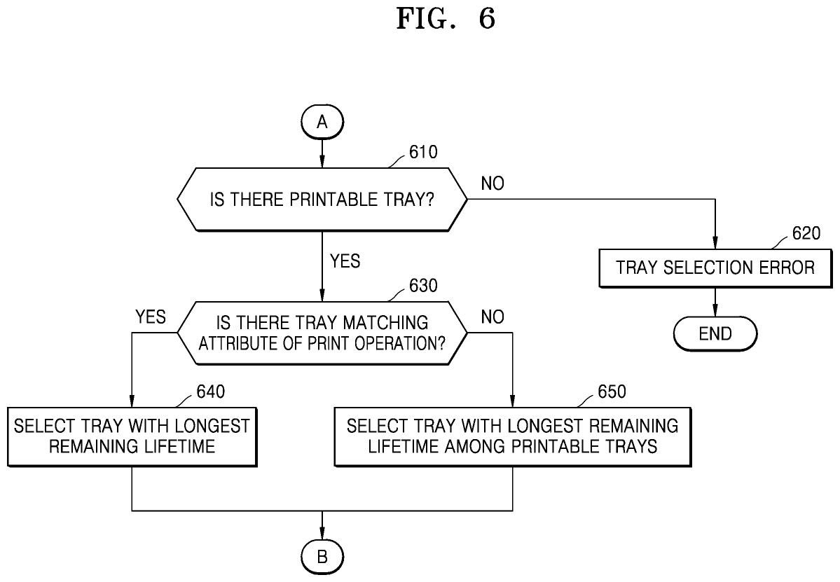

FIG. 6 is a flowchart illustrating a process of selecting a tray to be used for an image forming operation among a plurality of trays according to an example.

Referring to FIG. 6, a process of selecting a tray to be used for an image forming operation from among the plurality of trays 150 will be described by using an example of a case in which the image forming operation is a print operation.

In operation 610, the image forming apparatus 100 may determine whether there is a printable tray among the plurality of trays 150. For example, the image forming apparatus 100 may determine whether there is a printable tray by determining whether there is print medium P loaded among the plurality of trays 150.

In operation 620, when there is no printable tray among the plurality of trays 150, the image forming apparatus 100 may perform tray selection error processing. For example, the image forming apparatus 100 may output a tray selection error message informing the user that there is no printable tray.

In operation 630, when there is a printable tray among the plurality of trays 150, the image forming apparatus 100 may determine whether there is a tray matching an attribute of a print operation.

In operation 640, when there is a tray matching the attribute of the print operation, the image forming apparatus 100 may select a tray with the longest remaining life.

In operation 650, when there is no tray matching the attribute of the print operation, the image forming apparatus 100 may select a tray with the longest remaining life among the printable trays. In this case, the image forming apparatus 100 may be set to automatically select a next-best tray when there is no tray matching the attribute of the print operation. When there is no setting for automatically selecting a next-best tray, the image forming apparatus 100 may perform tray selection error processing.

Referring again to FIG. 5, in operation 530, the image forming apparatus 100 may perform the requested image forming operation on the print medium supplied from the tray selected as a tray to be used for the image forming operation.

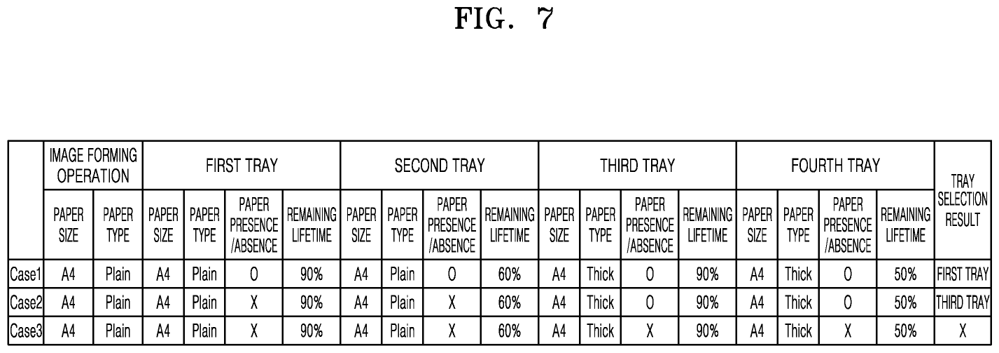

FIG. 7 is a diagram illustrating a result of selecting a tray by an image forming apparatus in various cases in which a plurality of trays are in different states according to an example.

Referring to FIG. 7, a result of selecting a tray by the image forming apparatus 100 will be described by using an example of cases 1 to 3 in which the plurality of trays 150 are in different states for the same image forming operation. FIG. 7 illustrates a result of automatically selecting a tray according to a presence/absence of a printing medium P (e.g., paper), a paper size, a paper type, and a remaining lifetime of paper loaded into each tray in the image forming apparatus 100 including a first tray, a second tray, a third tray, and a fourth tray.

In the example of FIG. 7, a user of the image forming apparatus 100 has requested the image forming apparatus 100 for an image forming operation after setting the image forming apparatus 100 to output an A4 size document on plain paper. In this case, in the image forming apparatus 100, the first tray is set for an A4 plain paper, the second tray is set for an A4 plain paper, the third tray is set for an A4 thick paper, and the fourth tray is set for an A4 thick paper. Also, the remaining lifetime of each tray is determined to be 90% for the first tray, 60% for the second tray, 90% for the third tray, and 50% for the fourth tray.

In case 1, because all the trays have loaded paper set for each tray, all the trays are in a printable state. Thus, each of the first tray, the second tray, the third tray, and the fourth tray may be determined to be a printable tray. Among them, the trays matching the paper size and the paper type of the requested image forming operation are the first tray and the second tray. The image forming apparatus 100 may select the first tray with the longest remaining lifetime among the first tray and the second tray.

In case 2, because the first tray and the second tray are not loaded with paper, the third tray and the fourth tray may be determined to be printable trays. Among them, there is no tray matching both the paper size and the paper type of the requested image forming operation. The image forming apparatus 100 may select the third tray with the longest remaining lifetime among the third tray and the fourth tray.

In case 3, because no paper is loaded in any of the trays, printing is impossible. Thus, because there is no printable tray, the image forming apparatus 100 may not select a tray and may perform tray selection error processing.

The above example method of controlling the image forming apparatus 100 including the plurality of trays 150 may be implemented in the form of a non-transitory computer-readable storage medium storing instructions or data executable by a computer or a processor. It may be written as a program executable in a computer and may be implemented in a general-purpose digital computer that operates the program by using a non-transitory computer-readable storage medium. The non-transitory computer-readable storage medium may be Read-Only Memory (ROM), Random-Access Memory (RAM), flash memory, Compact Disk Read-Only Memory (CD-ROM), Compact Disk Recordable (CD-R), CD+R, Compact Disk Rewritable (CD-RW), CD+RW, Digital Versatile Disk Read-Only Memory (DVD-ROM), Digital Versatile Disk Recordable (DVD-R), DVD+R, Digital Versatile Disk Rewritable (DVD-RW), DVD+RW, Digital Versatile Disk Random-Access Memory (DVD-RAM), Blu-ray Disk Read-Only Memory (BD-ROM), Blu-ray Disk Recordable (BD-R), Blu-ray Disk Recordable Low to High (BD-R LTH), Blu-ray Disk Recordable Erasable (BD-RE), magnetic tapes, floppy disks, magneto-optical data storages, optical data storages, hard disks, Solid-State Disk (SSD), or any device that may store instructions or software, related data, data files, and data structures and may provide instructions or software, related data, data files, and data structures to a processor or computer to enable the processor or computer to execute instructions.

What is claimed is:

1. An image forming apparatus including a plurality of trays, the image forming apparatus comprising:
a plurality of sensors to measure at least one of noise or vibration occurring in the plurality of trays;
a processor to select a tray to be used for an image forming operation based on a remaining lifetime of each of the plurality of trays estimated based on data about at least one of the noise or the vibration measured by the plurality of sensors; and
an image forming unit to perform an image forming operation on a print medium supplied from the selected tray.

2. The image forming apparatus of claim 1, wherein the processor is to select a tray with a longest remaining lifetime by comparing the remaining lifetime of each of the plurality of trays whenever there is a request for the image forming operation.

3. The image forming apparatus of claim 1, wherein the remaining lifetime of each of the plurality of trays is further estimated based on at least one of a feed failure rate or a feed count of each tray.

4. The image forming apparatus of claim 1, wherein the plurality of sensors respectively correspond to the plurality of trays.

5. The image forming apparatus of claim 1, wherein the processor is to estimate the remaining lifetime of each of the plurality of trays by comparing the data about at least one of the noise or the vibration measured by the plurality of sensors with reference data mapped and stored for each remaining lifetime of each tray.

6. The image forming apparatus of claim 1, further comprising a communication interface device,
wherein the processor is to determine the remaining lifetime of each of the plurality of trays based on information received from a diagnostic server through the communication interface device in response to transmission of the data about at least one of the noise or the vibration measured by the plurality of sensors to the diagnostic server.

7. The image forming apparatus of claim 1, wherein each of the plurality of sensors is located at a predetermined position relative to a print medium feed device provided at each of the plurality of trays to supply a print medium loaded into each of the plurality of trays to the image forming unit.

8. A method of controlling an image forming apparatus including a plurality of trays, the method comprising:
estimating a remaining lifetime of each of the plurality of trays based on data about at least one of noise or vibration measured by a plurality of sensors measuring at least one of noise or vibration occurring in the plurality of trays;
selecting a tray to be used for an image forming operation based on the estimated remaining lifetime of each of the plurality of trays; and
performing an image forming operation on a print medium supplied from the selected tray.

9. The method of claim 8, wherein the selecting of the tray comprises selecting a tray with a longest remaining lifetime by comparing the remaining lifetime of each of the plurality of trays whenever there is a request for the image forming operation.

10. The method of claim 8, wherein the remaining lifetime of each of the plurality of trays is further estimated based on at least one of a feed failure rate or a feed count of each tray.

11. The method of claim 8, wherein the plurality of sensors respectively correspond to the plurality of trays.

12. The method of claim 8, wherein the estimating of the remaining lifetime of each of the plurality of trays comprises estimating the remaining lifetime of each of the plurality of trays by comparing the data about at least one of the noise or the vibration measured by the plurality of sensors with reference data mapped and stored for each remaining lifetime of each tray.

13. The method of claim 8, wherein the estimating of the remaining lifetime of each of the plurality of trays comprises estimating the remaining lifetime of each of the plurality of trays based on information received from a diagnostic server in response to transmission of the data about at least one of the noise or the vibration measured by each of the plurality of sensors to the diagnostic server.

14. The method of claim 8, wherein each of the plurality of sensors is located at a predetermined position relative to a print medium feed device provided at each of the plurality of trays to supply a print medium loaded into each of the plurality of trays to an image forming unit.

15. A non-transitory computer-readable storage medium storing processor-executable instructions, the non-transitory computer-readable storage medium comprising:
instructions for estimating a remaining lifetime of each of a plurality of trays based on data about at least one of noise or vibration measured by a plurality of sensors measuring at least one of noise or vibration occurring in the plurality of trays;
instructions for selecting a tray to be used for an image forming operation based on the estimated remaining lifetime of each of the plurality of trays; and
instructions for performing an image forming operation on a print medium supplied from the selected tray.
